(19) United States
(12) Patent Application Publication
(10) Pub. No.: US 2010/0064065 A1
(43) Pub. Date: Mar. 11, 2010

(54) Connection Device for Connecting a Plurality of Peripheral Devices and Operating Method

(76) Inventors: Robert Depta, Augsburg (DE); Reinhold Gruber, Kissing (DE)

Correspondence Address: SLATER & MATSIL, L.L.P., 17950 PRESTON RD, SUITE 1000, DALLAS, TX, 75252-5793, US

(21) Appl. No.: 12/556,809

(22) Filed: Sep. 10, 2009

(30) Foreign Application Priority Data
Sep. 10, 2008 (DE) 10 2008 046 577.1

(51) Int. Cl. G06F 3/00

(52) U.S. Cl. 710/14; 710/36

(57) ABSTRACT

A connection device can be used for the connection of a plurality of peripheral devices to at least one host adapter. Each of the plurality of peripheral devices, as well as the host adapter, complies with a first and/or second data transmission protocol. A first or a second operating mode of the connection device is selected during an initialization phase.

This application claims priority to German Patent Application 10 2008 046 577.1, which was filed Sep. 10, 2008 and is incorporated herein by reference.

### TECHNICAL FIELD

The invention relates to a connection device for connecting a plurality of peripheral devices to at least one host adapter, wherein each of the plurality of peripheral devices, as well as the host adapter, complies with a first and/or a second data-transmission protocol.

In addition, the invention relates to an operating method for a connection device for connecting a plurality of peripheral devices to at least one host adapter.

### BACKGROUND

In the field of electronic data processing, an ever larger concentration of services is taking place in computing centers, so that more and more extensive and powerful arrangements are required for their processing. Simultaneously, the performance of data transmission channels used for connecting the components of such arrangements is increasing, so that more and more peripheral devices can be operated on a common host. Especially in the field of servers, operating a plurality of peripheral devices, particularly, storage devices, such as fixed disk drives or tape drives, on a common host adapter of a host computer is known. In order to improve the utilization of the peripheral devices, connecting the same peripheral devices by means of connection devices to a plurality of host adapters of different host computers is also known. Here, in the field of data storage, two different connection types with associated data transmission protocols have become widespread.

The relatively inexpensive Serial ATA (SATA) system is used, in particular, for coupling fixed disks to a computer system. Originally conceived for the internal connection of fixed disk drives in a desktop computer, SATA host adapters as a rule provide only a few connection options for fixed disks. Nevertheless, in order to couple additional fixed disks, like those appearing, for example, in so-called Redundant Arrays of Independent Disks (RAID), to the host computer, so-called SATA port multipliers and SATA port selectors have been developed. In the case of a port multiplier, the drives share the available transfer bandwidth. In contrast, with a port selector, different transmission paths are connected between individual drives and host adapters, so that several host systems can simultaneously access one and the same drive. However, to avoid errors and, in particular, to ensure data consistency, the subscribed components must be coordinated by means of special access mechanisms.

Alternatively, the so-called Serial Attached SCSI (SAS) bus system and protocol for connecting a plurality of peripheral devices to an SAS host adapter is known, in particular, from the field of high-performance servers. As in the case of the SATA standard, a corresponding connection port is also required for each individual peripheral device. Therefore, for expanding the connections present on the host adapter, the standard defines so-called SAS expanders that allow the connection of additional SAS devices to an individual port of the host adapter, wherein the SAS expander takes over the switching. SAS devices and host adapters are relatively expensive, but allow a plurality of services and can simultaneously also access SATA storage drives. Conversely, however, SATA host adapters cannot access SAS devices.

In heterogeneous system environments, a plurality of different host adapters and peripheral devices that are configured, in part, according to the SAS standard and, in part, according to the SATA standard are often placed in series. Because SAS and SATA use the same plug standards for connecting the peripheral devices, incorrect cable connections and thus incorrect functions of the individual devices are possible. For the system manufacturer there is additionally the problem of stocking a large number of different coupling devices for connecting SAS and SATA drives to SAS and SATA host adapters, respectively. For example, it is typical to provide different back planes for rack servers and RAID systems that are constructed either according to the SAS standard or the SATA standard.

### SUMMARY

It is one challenge of the present invention to describe a connection device as universal as possible for connecting a plurality of peripheral devices to at least one host adapter with which an as large as possible number of different system configurations can be successfully constructed. Preferably, manual configuration should not be required for setting up the connection device.

According to a first aspect of the invention, a connection device of the type mentioned above has at least one first host port for connecting to the at least one host adapter, a plurality of device ports for connecting the plurality of peripheral devices, at least one switching device for the selective connection of the plurality of device ports to the first host port, at least one detection device for detecting the presence of a predetermined configuration signal according to a first data transmission protocol at the first host port, and at least one control device for selecting an operating mode of the connection device. Here, the control device is designed to switch the connection device during an initialization phase, if a predetermined configuration signal is detected at the first host port by the detection device, into a first operating mode according to the first data transmission protocol and, if the predetermined configuration signal is not detected, into a second operating mode according to the second data transmission protocol.

By monitoring the first host port during an initialization phase for the presence of a predetermined configuration signal, it can be detected whether the connection device is connected to a host adapter according to a first data transmission protocol or to a second data transmission protocol. Accordingly, the connection device can be switched into a corresponding first or second operating mode, in order to allow successful communications between the host adapter, the connection device, and, optionally, peripheral devices connected to this device.

According to another advantageous embodiment, the at least one detection device is designed for detecting the presence at the plurality of device ports of a predetermined configuration signal according to the first data transmission protocol and the control device is designed to allocate a first group of device ports among the plurality of device ports to the first host port, wherein the inclusion of a device port in a first group is defined as a function of the detection of the predetermined configuration signal by the detection device. By detecting and evaluating a predetermined configuration signal at the device ports, devices connected to the connection device can be automatically allocated to the first group. Here, the detection can be performed by the same detection device or by an additional detection device.

According to another advantageous embodiment, the control device is designed to allocate to the first group at least the device ports on which the predetermined configuration signal was detected when, in the initialization phase, the predetermined configuration signal was likewise detected at the first host port. By allocating devices that the predetermined configuration signal according to the first data transmission protocol makes available to the first group and thus to the first host port to which a host adapter is connected that likewise operates according to the first data transmission protocol, all of the devices according to the first data processing protocol can be successfully addressed.

According to another advantageous embodiment, the control device is designed to allocate to the first group only the device ports on which the predetermined configuration signal was not detected when, in the initialization phase, the predetermined configuration signal was likewise not detected at the first host port. By allocating and thus linking devices that do not provide the first configuration signal to a host adapter that likewise does not provide the first configuration signal, peripheral devices that operate according to the second data transmission protocol are connected to a host adapter that likewise operates according to the second data transmission protocol.

According to one advantageous embodiment, the connection device is characterized by at least one second host port, wherein the control device is designed to switch the connection device, if the predetermined configuration signal is detected at the first host port, and if the predetermined configuration signal is not detected on the second host port, into a third operating mode in which at least one device port is controlled according to the first transmission protocol and at least one other device port is controlled according to the second data transmission protocol. Through the use of a third operating mode in which different host adapters and/or peripheral devices that are connected to the connection device are controlled either according to the first transmission protocol or according to the second data transmission protocol, a mixed operating mode can be implemented for connecting different peripheral devices to different host adapters.

According to one advantageous embodiment, the control device is designed to allocate a second group of device ports among the plurality of device ports to the second host port. By allocating different peripheral devices to a second group of device ports on the second host port, different groups of peripheral devices can be allocated to the first or second host port.

According to another advantageous embodiment, the control device is designed to query a predetermined device property of at least the devices that are connected to device ports on which the predetermined configuration signal was not detected and to define the allocation of these devices as a function of the queried device property. By testing a device property, particularly, of the devices that are to be operated according to the second data transmission protocol, their connection to a first and/or second host adapter can be made dependent on their corresponding data processing capabilities.

According to one advantageous embodiment, the queried device property comprises a capability for multiple allocations and the control device is designed to allocate devices with a capability for multiple allocations both to the first group and also to the second group. Devices that are designed to be operated simultaneously on different host adapters thus can be allocated both to the first host adapter and also to the second host adapter.

According to another advantageous embodiment, the control device is designed to allocate the device ports to the first group and/or to the second group on the basis of an allocation table of a configuration device. By using an allocation table, deviations from the automatic allocation scheme can be taken into consideration, for example, in order to allocate predetermined peripheral devices to a predetermined host adapter.

According to another aspect of the invention, an operating method for a connection device is disclosed for connecting a plurality of peripheral devices to at least one host adapter. The operating method comprises the steps:
monitoring of a first host port for a predetermined configuration signal of the at least one host adapter,
selection of a first operating mode of the connection device when the predetermined configuration signal was detected during an initialization phase and a second operating mode when the predetermined configuration signal was not detected during the initialization phase,
monitoring of a plurality of device ports for the predetermined configuration signal of the plurality of peripheral devices, and
connection of a first group of peripheral devices among the plurality of peripheral devices to the at least one host adapter as a function of the monitoring of the first host port and/or the plurality of device ports for the predetermined configuration signal.

By monitoring both a first host port and also a plurality of device ports for a predetermined configuration signal, the data transmission protocols used by a host adapter and a plurality of peripheral devices can be determined and compatible devices can be allocated to one another.

According to another advantageous embodiment, the operating method is characterized by a monitoring of a second host port for the predetermined configuration signal of at least one second host adapter and a selection of a third operating mode of the connection device when the predetermined configuration signal was detected during an initialization phase at the first host port and the predetermined configuration signal was not detected during the initialization phase on the second host port. By detecting a mixed configuration using two different host adapters, different peripheral devices can be allocated to the corresponding, matching host adapter.

According to another advantageous embodiment, the at least one host port and/or the plurality of device ports use, during a data transmission phase, differential signaling and, in an initialization phase, non-differential signaling. By using differential or non-differential signaling, a data transmission phase can be differentiated from an initialization phase.

### BRIEF DESCRIPTION OF THE DRAWINGS

Additional advantageous embodiments are explained in detail in the subordinate claims, as well as in the following description of embodiments. The embodiments will be described in detail with reference to figures.

FIG. 1, shows an arrangement comprising a plurality of host systems that are connected via a connection device to a plurality of peripheral devices;

FIG. 2, shows a schematic diagram of a connection device according to one embodiment of the invention;

FIGS. 3A and 3B, show different configurations of a connection device for connecting peripheral devices to an individual host adapter;

FIGS. 4A and 4B, show different configurations of a connection device for connecting peripheral devices to a plurality of host adapters; and

FIG. 5, shows a flow chart of an operating method for a connection device according to an embodiment of the invention.

The following list of reference symbols may be used in conjunction with the drawings:
1 Computer arrangement
2 Host computer
3 Host adapter
4 Connection device
5 Host port
6 Device port
7 Fixed disk drive
8 Detection device
9 Switching device
10 Control device
11 Configuration device
12 Connection matrix for host ports
13 Connection matrix for device ports
50 Operating method
51 to 59 Method steps

### DETAILED DESCRIPTION OF ILLUSTRATIVE EMBODIMENTS

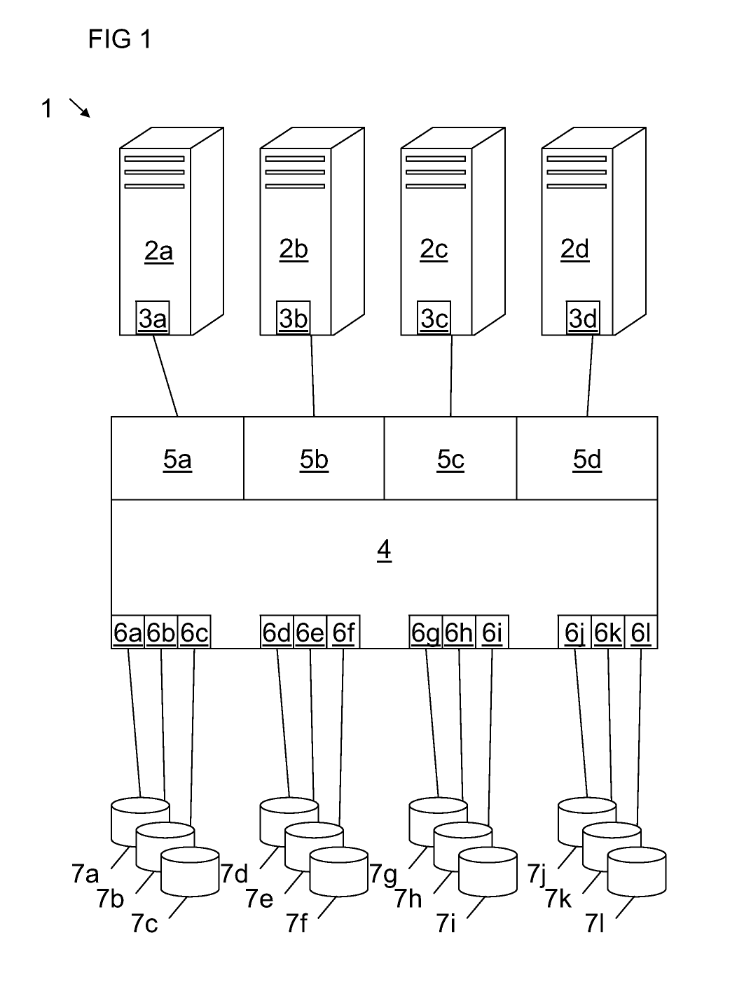

FIG. 1 shows a computer arrangement 1 with four host computers 2a to 2d. Each of the host computers 2a to 2d contains a host adapter 3a to 3d, respectively. By means of the host adapters 3a to 3d, the host computers 2a to 2d are coupled with a connection device 4. The connection device 4 is, for example, a so-called RAID system with a plurality of insert slots for storage drives. Alternatively, however, it could also be a switch for switching between different types of peripheral devices. In a particular example, the connection device 4 of the embodiment is a so-called back plane in a rack computer system.

In the embodiment, the connection device 4 has four host ports 5a-5d. Each of the host computers 2a to 2d is connected to one of the host ports 5a-5d, respectively. In addition, the connection device 4 in the embodiment has twelve device ports 6a to 6l. One peripheral device is connected to each of the device ports 6a to 6l. In the embodiment shown in FIG. 1 the peripheral devices are fixed disk drives 7a to 7l.

The shown embodiment is a heterogeneous computer system. For example, the host computers 2a and 2b each have a host adapter 3a and 3b, respectively, according to the SAS standard. In contrast, the host computers 2c and 2d are equipped with a host adapter 3c and 3d, respectively, according to the SATA standard. The fixed disk drives 7a to 7i are likewise, for example, fixed disk drives with an SAS interface, while the fixed disk drives 7j to 7l are equipped with an interface according to the SATA standard.

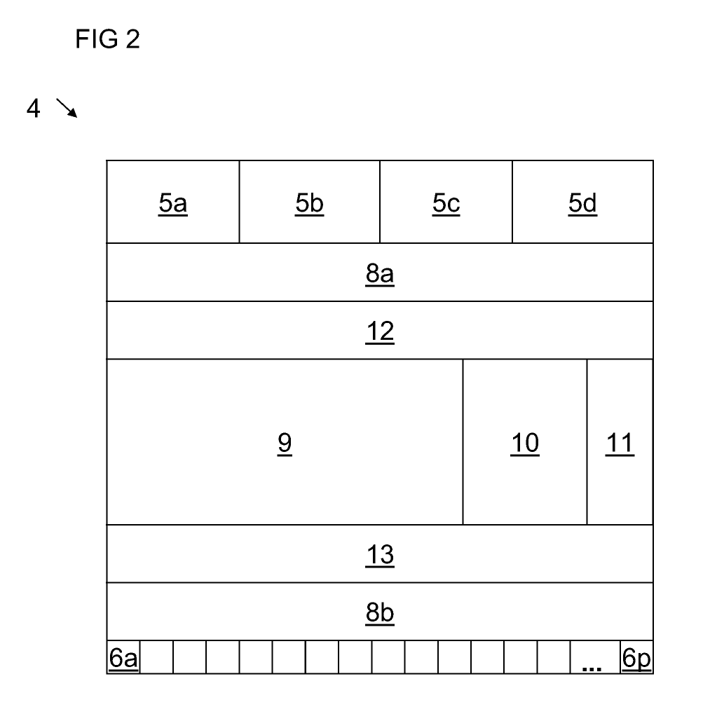

In order to allow correct functioning or correct allocation of all of the fixed disk drives 7 to the host adapters 3 of the host computer 2, the connection device 4 has a detection device that is described in detail below with reference to FIG. 2.

FIG. 2 shows a connection device 4 with four host ports 5a-5d and sixteen device ports 6a-6p. In addition, the connection device 4 comprises a first detection device 8a for detecting a predetermined configuration signal, in particular, a so-called COMSAS signal according to the SAS standard, at the host ports 5a-5d and a second detection device 8b for detecting the predetermined configuration signal at the device ports 6a-6p. By means of a switching device 9, the host ports 5a-5d can be connected selectively to the device ports 6a-6p. For example, the switching device 9 is a bridge or a switch that can switch one or more message channels from one or more of the host ports 5a-5d to one or more of the device ports 6a-6p.

In order to set the allocation of the host ports 5a-5d to the device ports 6a-6p, the connection device 4 has a control device 10 that allocates each of the device ports 6a-6p to one or more of the host ports 5a-5d as a function of control signals of the detection devices 8a and 8b and optionally additional configuration data stored in the connection device 4.

In addition, an optional configuration device 11 is provided that comprises a configuration port used for performing manual settings of the control device 10. Here, it can be, for example, an additional port for a control computer or a logical address region of the connection device that can be addressed by means of one of the host ports 5a-5d.

Finally, the connection device 4 comprises a connection matrix 12 for host ports and a connection matrix 13 for device ports. The connection matrix 12 for host ports determines which of the host ports 5a-5d are allocated to a host adapter 3 according to a first or second data transmission protocol. The connection matrix 13 for device ports determines the device ports 6a-6p peripheral to which devices according to the first or the second data transmission standard are connected and, optionally, whether these have the capability of being connected simultaneously to several host computers 2. Taking into consideration the information of the connection matrix 12 for host ports and the connection matrix 13 for device ports, the control device 10 determines the device ports 6a-6p to which the host ports 5a-5d are connected by the switching device 9.

The switching device 9, the control device 10, the configuration device 11, the detection devices 8a and 8b, the connection matrix 12 for host ports, and/or the connection matrix 13 for device ports can be constructed as separate hardware modules or as integrated components. In particular, for the implementation of the required protocols, programmable logic modules, such as FPGA, EPDL, or ASIC, can be used. Obviously, known control modules that operate according to the first and/or second data transmission protocol could also be combined with one another, in order to achieve the desired functionality.

In an embodiment, the first data transmission protocol is the SAS protocol. The second data transmission protocol is the SATA protocol. According to the SAS protocol for the initialization of a connection between a host adapter 3 or a peripheral device and a connection device 4, a link initialization is performed in which so-called COMSAS signaling is performed. COMSAS signaling involves a so-called out-of-band (OOB) signal whose signal levels lie outside of the typical specifications according to the SAS standard. In particular, non-differential signaling for the COMSAS signaling is used, while differential signaling for the data transmission is used at the host ports 5 or the device ports 6.

If a host computer 2 with a host adapter 3 according to the SAS standard is connected to a host port 5 of the connection device 4, the detection device 8a detects the COMSAS signal. In contrast, the SATA standard provides no link initialization with COMSAS signaling. If the detection device 8a detects the connection of a host adapter 3 to a host port 5, without a COMSAS signal being detected within a predetermined time period, then it is recorded in the connection matrix 12 for host ports that a SATA host adapter 3 is connected to the associated host port 5.

The control device 10 switches the connection device 4 and, in particular, the switching device 9 into a first operating mode that corresponds to the operation of an SAS expander when a COMSAS signal is detected on all of the host ports 5. In contrast, if the absence of a COMSAS signal is detected on all of the host ports 5a-5d by the detection device 8a, the control device 10 switches the connection device 4 into an operating mode as a SATA port multiplier or SATA port selector. Here, it is optionally determined by the configuration device 11 whether the connection device 4 is operated as a port multiplier or port selector.

The requirements for operating a switching device as an SAS expander or SATA port multiplier or SATA port selector are set by the appropriate standards. In particular, the document “Information technology—Serial Attached SCSI—2 (SAS-2),” Revision 14c of Jun. 30, 2008 of the T10 project of the Technical Committee of Accredited Standards Committee INCITS (International Committee for Information Technology Standards) describes the SAS standard. In contrast, the document “SERIAL ATA,” Revision 2.6 of Feb. 15, 2007 of the Serial ATA International Organization (SATA-IO) describes the SATA standard. The definitions and disclosure of both standards is explicitly incorporated into this application by reference.

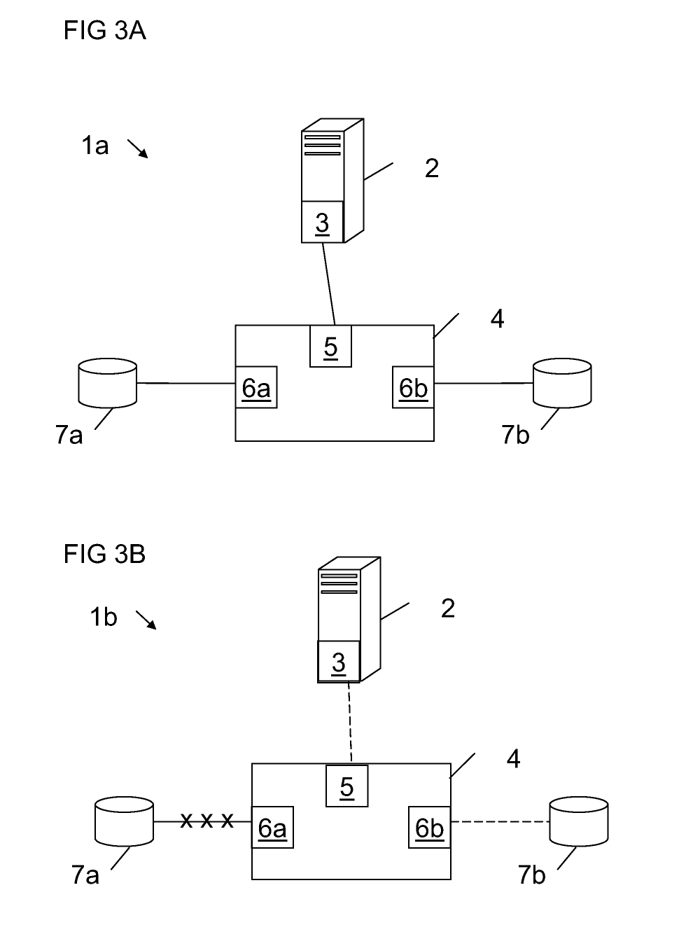

In FIG. 3A, a first configuration of a computer arrangement 1a with an individual host computer 2 is described. The host computer 2 contains a host adapter 3 according to the SAS standard. This is connected to an individual host port 5 and a connection device 4. Two fixed disk drives 7a and 7b are connected by means of two device ports 6a and 6b to the connection device 4. In this case, the control device 10 switches the connection device 4 into the first operating mode in which the connection device 4 is described as an SAS expander. In this way it is possible for the host computer 2 to access both the first fixed disk 7a, which is, for example, a fixed disk according to the SAS standard, and also the second fixed disk 7b, which is, for example, a fixed disk according to the SATA standard. The host adapter 3 automatically detects which protocol it must use for signaling with the first fixed disk 7a or the second fixed disk 7b. Here, the host adapter 3 uses, for example, the so-called SATA Tunneling Protocol (STP) for access to the SATA fixed disk 7b, in order to guarantee the inclusion of the SATA device in the logical SAS domain.

FIG. 3B shows a second computer arrangement 1b comprising a host computer 2 with a host adapter 3 according to the SATA standard. The host adapter 3 is connected by means of a host port 5 to a connection device 4. The connection device 4 is connected as in FIG. 3A by means of a first device port 6a or a second device port 6b to a first fixed disk drive 7a according to the SAS standard and to a second fixed disk drive 7b according to the SATA standard. Because the host adapter 3 is not suitable for accessing the first fixed disk 7a according to the SAS standard, the logical connection between the first fixed disk drive 7a and the connection device 4 is interrupted. Here, the first fixed disk drive 7a is held in an inactive state, for example, a standby or energy-saving state corresponding to the SAS standard. Thus, only the second fixed disk drive 7b is allocated to the host computer 2 and can be addressed by this computer by means of the SATA protocol. Here, the connection device 4 operates either as a port multiplexer or port selector according to a preset.

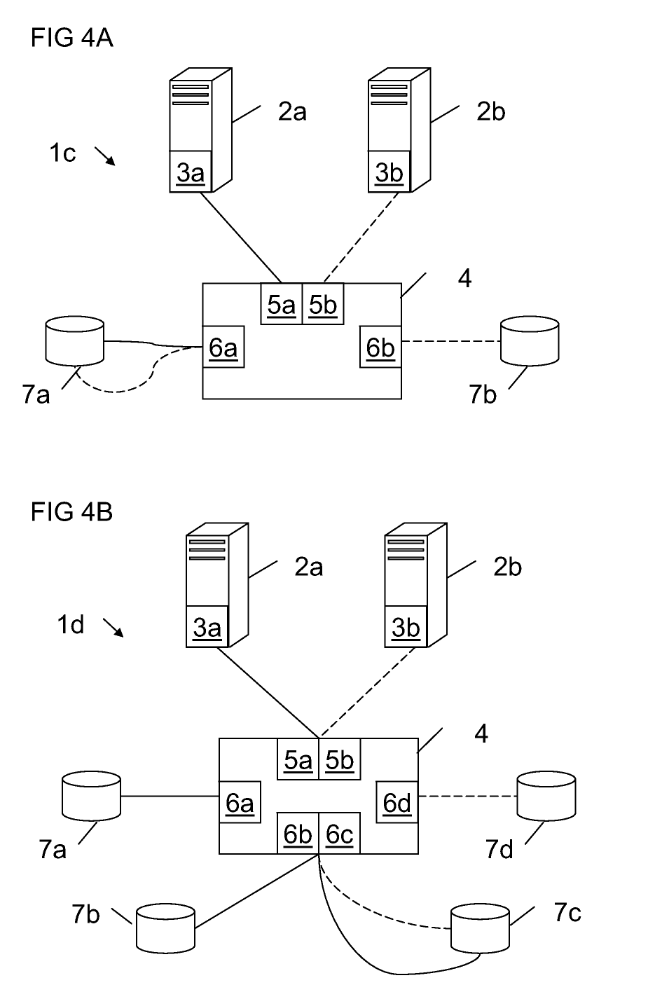

The flexibility of the connection device 4 is shown, in particular, in the connection of several host computers 2 to the same connection device for the common access to a plurality of peripheral devices. Such configurations are shown as examples in FIGS. 4A and 4B.

FIG. 4A shows a third computer arrangement 1c comprising two host computers 2a and 2b, each with SATA host adapters 3a and 3b, respectively. The host adapters 3a and 3b are connected to host ports 5a and 5b, respectively, of a connection device 4. A first fixed disk 7a and a second fixed disk 7b are connected, both according to the SATA standard, by means of device ports 6a and 6b, respectively, to the connection device 4. The first fixed disk 7a supports a so-called anti-collision mechanism. In contrast, the second fixed disk 7b does not support an anti-collision mechanism. This device property of the fixed disks 7a and 7b is queried by the control device 10 at initialization of the device ports 6. The fixed disk 7a with the anti-collision mechanism is simultaneously available for all of the host computers 2. The fixed disk 7b without an anti-collision mechanism could similarly be connected by each of the host adapters 3 of the host computer 2. However, in order to prevent collisions in the accesses to different host computers 2, the switching device 9 connects the device port 6b only alternately to the host port 5a or 5b, so that accesses of the host computer 2a or 2b to the second fixed disk 7b can be performed only one after the other. Thus, the connection device 4 takes over the anti-collision management for the fixed disk drive 7b.

If a COMSAS signal is detected by the detection device 8a on at least one occupied host port 5 and no COMSAS signal is detected on at least one other occupied host port 5, then the control device 10 switches the connection device 4 into a third operating mode that mixes elements of the first and second operating modes and is consequently described below with reference to an additional example configuration.

FIG. 4B shows a fourth computer arrangement 1d in which the connection device 4 is operated in a mixed third operating mode. Two host computers 2a and 2b are each connected to the connection device 4 with host adapters 3a and 3b, respectively. The host adapter 3a operates according to the SAS standard and the host adapter 3b operates according to the SATA standard. In addition, four fixed disk drives 7a to 7d are connected to the connection device 4 by means of four device ports 6a to 6d. The first fixed disk 7a and the second fixed disk 7b are SAS fixed disks. The third and fourth fixed disks 7c and 7d, are each fixed disks according to the SATA standard. The third fixed disk 7c supports a so-called multi-affiliation mode (MAM) that permits competitive access by host adapter 3a or 3b. In contrast, the fourth fixed disk 7d is not capable of the multi-affiliation mode. The third operating mode permits the use of different configurations.

In a configuration of the connection device 4 referred to as mono-mode routing, the SAS fixed disks 7a and 7b are allocated exclusively to the SAS host adapter 3b and the SATA fixed disks 7c and 7d are allocated exclusively to the SATA adapter 3b.

In a configuration referred to as multi-mode routing, the SATA fixed disks 7c and 7d are also allocated to the host adapter 3a according to the SAS data transmission protocol, wherein accesses as described above are executed one after the other.

In a configuration referred to as multi-affiliation mode routing and shown in FIG. 4B, the fixed disk drives 7a and 7b according to the SAS standard are allocated to the host adapter 3a of the host computer 2a according to the SAS standard. The third fixed disk 7c is allocated both to the first host computer 2a and also to the second host computer 2b and is simultaneously visible to both host adapters 3a and 3b. The fourth fixed disk 7d according to the SATA standard is allocated exclusively to the second host computer 2b according to the SATA standard. In this way, an especially flexible access of the host computer 2 to the fixed disk drives 7a to 7d is possible.

Finally, in so-called selective-mode routing, manual allocation of SAS or SATA drives to predetermined host adapters is possible. Optionally, peripheral devices according to the first data transmission protocol that have not been allocated explicitly are allocated to host adapters according to the first data transmission protocol and non-allocated fixed disk drives according to the second data transmission protocol are allocated to host adapters according to the second data transmission protocol.

The connection device 4 is configured essentially automatically by the control device 10 using the connection matrix 12 for host ports or connection matrix 13 for device ports determined by the detection device 8. In addition, manual configuration can be performed by means of the configuration device 11. Here, the signaling of settings can be performed either in-band or out-of-band by means of the host computer 2 or additional control computers. For example, the so-called SAS management protocol (SMP), special data buses, such as, I²C, or user-specific commands for the connection device 4 are suitable for this purpose. Likewise, the operating mode of the connection device 4 can be forced into a designated operating mode by the configuration device 11 or input elements arranged on the connection device 4. For example, the device could be operated deterministically as an SAS expander or alternatively as an SATA port multiplier or selector by pressing a corresponding button.

Preferably, however, the configuration of the connection device 4 is realized by means of events triggered by the detection devices 8a or 8b. In particular, a COMSAS signal detected during the operation of the connection device 4 could also be used to switch the connection device 4 into the first or third operating mode, after having performed link initialization with a host adapter according to the first data transmission protocol. Conversely, the connection device 4 could be switched into the second or third operating mode of a connection of a host adapter that provides no COMSAS signal is detected.

The automatic configuration of the connection device 4 by the detection devices 8 has the additional advantage that the connection device 4 does not require a battery for storing configuration data. This in turn increases the reliability and reduces the maintenance costs during the operation of the connection device 4.

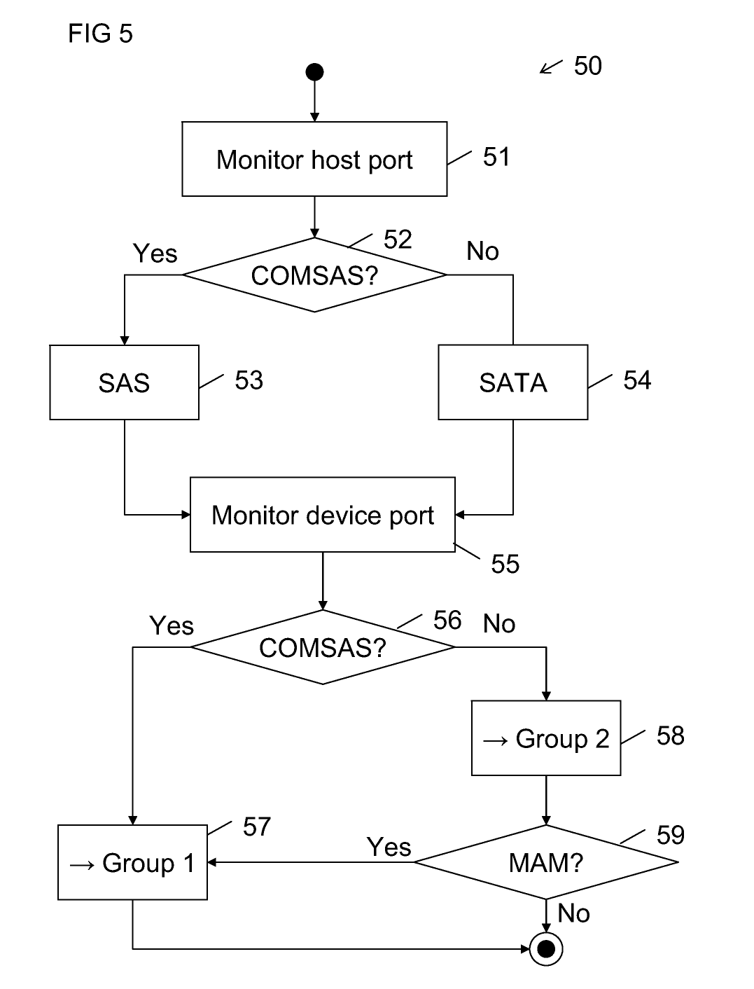

FIG. 5 shows a flow chart of an operating method 50 for automatically configuring and operating the connection device 4.

In a first step 51, one or more host ports 5 are monitored. In a step 52, if a predetermined configuration signal is detected, an out-of-band COMSAS signal in the present embodiment, the connection device 4 is switched in step 53 into a first operating mode, for example, as an SAS expander. If no COMSAS signal is detected, the connection device 4 is switched in step 54 into a second operating mode according to the second data transmission protocol. For example, the connection device 4 is configured as a SATA port multiplier or SATA port selector. As long as the connection device 4 has several host ports 5, the setting of the first or second operating mode can be performed for each host port 5 and can be recorded in the connection matrix 12 for host ports, so that, as described above, mixed operating modes for the connection device 4 can also be produced.

In another step 55, the device ports 6 of the connection device 4 are monitored. In a step 56, if the predetermined configuration signal, that is, for example, the COMSAS signal, is detected on a device port 6, this device port 6 is allocated to a first group. This is performed in step 57. Alternatively, i.e., if no COMSAS signal was detected in step 56, a peripheral device connected to the associated device port 6 is allocated in a step 58 to a second group. However, if the connected device has properties suitable for being simultaneously addressed by host adapters 3 according to the first data transmission protocol, for example, if it is capable of multi-association mode, then it is also allocated to the first group in step 57 after a corresponding test in step 59.

It is noted that in FIG. 5 only the automatic configuration of the host ports 5 and the device ports 6 of the connection device 4 are shown. As an alternative or in addition to the automatic configuration, a manual allocation of host ports 5 or device ports 6 to a first group or to a second group is obviously also possible, as was already described above.

In addition, the detection of configuration signals could also be performed in a sequence that is different from that shown and, in particular, also continuously, so that the connection device could be switched even during operation into a different operating mode or the allocation of peripheral devices connected to it could be updated. This is advantageous especially in the use of RAID systems that often permit an exchange of individual components during operation (“hot swapping”).

Instead of the fixed disk drives 7, other peripheral devices, for example, tape drives, could obviously also be detected at the device ports 6 and the device ports 6 could be configured accordingly. Finally, it is possible to connect a host computer 2 by means of a plurality of host adapters 3 to one and the same connection device 4, in order to create particularly powerful and/or fail-safe computer arrangements.

What is claimed is:

1. A connection device for connecting a plurality of peripheral devices to at least one host adapter, wherein each of the plurality of peripheral devices, as well as the at least one host adapter, complies with a first and/or a second data transmission protocol, the connection device comprising:
at least one first host port for connecting to the at least one host adapter;
a plurality of device ports for connecting the plurality of peripheral devices;
at least one switching device for selective connection of the plurality of device ports to the at least one first host port;
at least one detection device for detection of a provision of a predetermined configuration signal according to the first data transmission protocol at the at least one first host port; and
at least one control device for selection of an operating mode of the connection device, wherein the at least one control device is designed to switch the connection device into a first operating mode according to the first data transmission protocol during an initialization phase if the predetermined configuration signal is detected on a first host connection by the at least one detection device, and into a second operating mode according to the second data transmission protocol if the predetermined configuration signal is not detected.

2. The connection device according to claim 1, wherein the at least one detection device is designed for detection of a provision of the predetermined configuration signal according to the first data transmission protocol at the plurality of device ports and the at least one control device is designed to allocate a first group of device ports among the plurality of device ports at the at least one first host port, wherein inclusion of a device port in the first group is determined as a function of a detection of the predetermined configuration signal at the corresponding device port by the at least one detection device.

3. The connection device according to claim 2, wherein the at least one control device is designed to allocate at least the device ports to the first group on which the predetermined configuration signal was detected, if, in the initialization phase, the predetermined configuration signal was detected at the at least one first host port.

4. The connection device according to claim 2, wherein the at least one control device is designed to allocate all of the device ports to the first group, if, in the initialization phase, the predetermined configuration signal was detected at the at least one first host port.

5. The connection device according to claim 2, wherein the at least one control device is designed to allocate only the device ports to the first group on which the predetermined configuration signal was not detected, if, in the initialization phase, the predetermined configuration signal was likewise not detected at the at least one first host port.

6. The connection device according to claim 2, further comprising at least one second host port, wherein the at least one control device is designed to switch the connection device, if the predetermined configuration signal is detected at the at least one first host port and if the predetermined configuration signal is not detected on the at least one second host port, into a third operating mode in which at least one device port is controlled according to the first data transmission protocol and at least one other device port is controlled according to the second data transmission protocol.

7. The connection device according to claim 6, wherein the at least one control device is designed to allocate a second group of device ports among the plurality of device ports to the at least one second host port.

8. The connection device according to claim 7, wherein the at least one control device is designed to allocate to the second group of device ports at least the device ports that were not already allocated to the first group.

9. The connection device according to claim 7, wherein the at least one control device is designed to determine the inclusion of a device port in the second group of device ports as a function of detection of the predetermined configuration signal at the corresponding device port by the at least one detection device.

10. The connection device according to claim 7, wherein the at least one control device is designed to query a predetermined device property of at least the plurality of peripheral devices that are connected to the plurality of device ports on which the predetermined configuration signal was not detected and to determine the allocation of these peripheral devices as a function of the queried device property.

11. The connection device according to claim 10, wherein the predetermined device property comprises a capability for multiple allocation and the at least one control device is designed to allocate peripheral devices with a capability for multiple allocations to both the first group and also the second group.

12. The connection device according to claim 7, wherein the at least one control device is designed to allocate the plurality of device ports to the first group and/or to the second group on the basis of an allocation table of a configuration device.

13. The connection device according to claim 1, wherein the first data transmission protocol corresponds to Serial Attached SCSI protocol (SAS), the connection device can be operated at least as an SAS expander, and a first configuration signal corresponds to a COMSAS signal.

14. The connection device according to claim 1, wherein the second data transmission protocol corresponds to Serial ATA protocol (SATA) and the connection device can be operated at least as a SATA port multiplier and/or SATA port selector.

15. A method for operating a connection device for connecting a plurality of peripheral devices to at least one host adapter, the method comprising:
monitoring a first host port for a predetermined configuration signal of the at least one host adapter;
selecting a first operating mode of the connection device, when the predetermined configuration signal was detected during an initialization phase, and a second operating mode, when the predetermined configuration signal was not detected during the initialization phase;
monitoring a plurality of device ports for the predetermined configuration signal of the plurality of peripheral devices; and
connecting a first group of peripheral devices among the plurality of peripheral devices to the at least one host adapter as a function of the monitoring of the first host port and/or the plurality of device ports for the predetermined configuration signal.

16. The method for operating a connection device according to claim 15, further comprising:
monitoring a second host port for the predetermined configuration signal of at least one second host adapter; and
selecting a third operating mode of the connection device, when the predetermined configuration signal was detected during the initialization phase at the first host port and the predetermined configuration signal was not detected during the initialization phase on the second host port.

17. The method for operating a connection device according to claim 15, wherein the at least one first host port and/or the plurality of device ports is used during a data transmission phase for differential signaling and is used in the initialization phase for non-differential signaling.
